(19) United States
(12) Patent Application Publication
(10) Pub. No.: US 2004/0070578 A1
(43) Pub. Date: Apr. 15, 2004

(54) Electronic circuit, electro-optical device, and electronic apparatus

(75) Inventor: Toshiyuki Kasai, Okaya-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/642,740

(22) Filed: Aug. 19, 2003

(30) Foreign Application Priority Data
Aug. 22, 2002 (JP) 2002-242473

(51) Int. Cl. G09G 5/00

(52) U.S. Cl. 345/204

(57) ABSTRACT

To provide an electronic circuit, an electro-optical device, and an electronic apparatus in which a high accuracy of predetermined analog current can be supplied by suppressing variations of threshold value voltage of each current generating transistor. A voltage rising transistor Tc of a compensating circuit part 40 for compensating each threshold value voltage at first to sixth current-supplying transistors 33a to 33f is arranged and is formed. Further, a source of the voltage rising transistor Tc at the compensating circuit part 40 is connected to an input port Pi of a digital-analog converting part 30. Further, a drain of the voltage rising transistor Tc is connected to each gate of the first to sixth current-supplying transistors 33a to 33f. Further, a reference voltage Vref supplied from a power source supply part to the input port Pi is increased at the compensating circuit part 40 as much as the threshold voltage value of the first to sixth current-supplying transistors 33a to 33f for supplying to each gate of the first to sixth current-supplying transistors 33a to 33f.

### BACKGROUND OF THE INVENTION

1. Field of Invention

The present invention relates to an electronic circuit, an electro-optical device, and an electronic apparatus.

2. Description of Related Art

In recent years, electro-optical devices employing current driving elements referred to as organic EL elements have attracted public attention. One of the driving methods of the electro-optical devices using these types of organic EL elements is an active matrix driving method.

Electro-optical devices of the active matrix driving method include a display panel part in which a plurality of pixel circuits having organic EL elements is arranged in the form of a matrix. The pixel circuits control light-emitting luminance gradations of the organic EL elements in response to signals supplied to the pixel circuits.

To be more specific, data lines are disposed at the display panel part in the electro-optical device of the active matrix driving method. Each data line is connected to corresponding pixel circuits. Each pixel circuit is connected to a data line driving circuit via data lines. The data line driving circuit is connected to a controller for outputting image data for executing display on the display panel part.

The data line driving circuit serves to generate a driving signal corresponding to image data output from the controller. Further, the driving signal generated by the data line driving circuit is supplied to each pixel circuit via the data lines. The pixel circuits generate a current corresponding to a current value of the driving signal and supply the generated currents to the organic EL elements, thereby controlling the light-emitting luminance gradation of the organic EL elements.

In the data line driving circuit of the electro-optical device of the active matrix driving method thus described, a digital-analog (D/A) converting circuit is equipped thereto for converting the image data which is a digital signal output from the controller to a driving signal of analog current. FIG. 16 is a schematic construction diagram for illustrating a data line driving circuit of the electro-optical device equipped with the pixel circuits of the active matrix driving method. The data line driving circuit 70 includes a plurality of unit line drivers 71 and a voltage supply part 72 for supplying a reference voltage Vref to each unit line driver 71. The unit line driver 71 is connected to the pixel circuits (not shown) via data lines 74. Further, each unit line driver 71 is connected to a controller (not shown) for outputting the image data.

The voltage supply part 72 is connected to each voltage supply terminal 75 of the unit line driver 71 via each voltage supply line Q relative to each unit line driver 71. Further, the reference voltage Vref supplied to each voltage supply terminal 75 is a direct current voltage having almost equal voltage value.

FIG. 17 is a circuit diagram of the D/A converting circuit 73 disposed at each unit line driver 71. The D/A converting circuit 73 is a current-output type D/A converting circuit for generating an analog current corresponding to 6-bit image data. The D/A converting circuit 73 is formed with analog output signal lines 76a to 76f, switching transistors 77a to 77f, current-supplying transistors 78a to 78f, and digital input signal lines 79a to 79f.

The analog output signal lines 76a to 76f are connected in parallel to each other, and are connected to an output terminal 81. The analog output signal lines 76a to 76f are connected to the switching transistors 77a to 77f, respectively. Further, the switching transistors 77a to 77f are connected to the current-supplying transistors 78a to 78f, respectively.

Each gate of the switching transistors 77a to 77f is connected to digital input signal lines 79a to 79f and the digital input signal lines 79a to 79f are connected to a controller (not shown) for outputting the 6-bit image data.

Each gate of the current-supplying transistors 78a to 78f is commonly connected to a voltage supply line 80, which is connected to the voltage supply terminal 75. The current-supplying transistors 78a to 78f are transistors each functioning as a constant current source for outputting a predetermined current. The current-supplying transistors 78a to 78f are sequentially established to have a relative ratio of gain factor β at 1:2:4:8:16:32. Further, each threshold value voltage of the current-supplying transistors 78a to 78f is close to Vth and the current Io=(½) β (Vref−Vth)² when each transistor is operated within a saturation region. Here, β is a gain factor of a transistor and β is defined as β=(μCW/L), where μ is a moving degree of carrier, C is a capacity of gate, W is a width of channel, and L is length of the channel. Further, Vref is a reference voltage supplied to the voltage supply terminal 75. As the current-supplying transistors 78a to 78f are respectively arranged at adjacent positions, the threshold value voltage Vth of each current-supplying transistor 78a to 78f is possible to restrain up to the degree of disregarding the threshold value voltage of the transistors 78a to 78f. In this case, the current lo flowing in each of the transistors 78a to 78f has a current value in proportion to the gain factor β. In other words, the relative ratio of the current output from the current-supplying transistors 78a to 78f is at 1:2:4:8:16:32, respectively.

The ON-OFF control of the current-supplying transistors 78a to 78f is carried out on the basis of the 6-bit image data output from the controller. The lowermost bit of the 6-bit image data is supplied to a first current supply transistor 77a whose gain factor β is the smallest (in other words, relative value of β is 1) and the uppermost bit is supplied to a sixth current-supplying transistor 77f whose gain factor β is the largest (in other words, relative value of β is 32).

Further, in response to the image data output from the controller, the switching transistors 77a to 77f are appropriately selected to carry out the ON/OFF control. As a result, from an output terminal 81, there is output as a driving signal an analog output current Im where each current output from the current-supplying transistors 78a to 78f is synthesized. Further, the pixel circuits control the light-emitting luminance gradation of the organic EL element corresponding to the analog output current Im of the driving signal generated by the data line driving circuit 70 via the data line 74 connected to the output terminal 81.

### SUMMARY OF THE INVENTION

However, the aforementioned D/A converting circuit 73 rises a problem in which each unit line driver 71 is different at its formed position, so that, particularly, in the unit line drivers formed on positions which have very distanced, the threshold value voltages Vth of the current-supplying transistors 78a to 78f, which are included in each unit line driver, vary greatly due to manufacturing errors. In other words, there occurs a variation of the threshold value voltage Vth at each unit line driver 71. On the other hand, reference voltage Vref supplied to voltage supply terminal 75 of each unit line driver 71 has almost the same value regardless of the formed position of the unit line driver 71 as mentioned above. Therefore, the analog output current Im of the driving signal output from each unit line driver 71 is different for each unit line driver 71 even if it is based on the same image data. As a result, characteristic of luminance gradation of the organic EL element at each pixel circuit is varied, thereby resulting in a decreased display quality of the electro-optical device.

The present invention is disclosed to solve the above-mentioned problems and it is an object of the present invention to provide an electronic circuit, electro-optical device, and an electronic apparatus adapted to restrain variations of threshold value voltage of each current generating transistor, thereby capable of supplying a predetermined analog current with improved accuracy.

The electronic circuit according to the present invention changes a reference voltage value with a transforming circuit to supply it to control terminals of a plurality of current-generating active elements, establishes a conduction state of the plurality of the current-generating active elements, selects some of the plurality of current-generating active elements based on signals, and generates a current having a current level corresponding to the signal by superposing currents passing through the current-generating active elements selected by the signal, among the plurality of current-generating active elements.

According to the electronic circuit of the present invention, accuracy of the current output from the current-generating active element can be controlled for improvement in response to the signal.

The electronic circuit according to the present invention comprises a plurality of current-generating active elements, a transforming circuit for generating an applied voltage which is applied to control terminals of the plurality of current-generating active elements by changing a reference voltage, and selection transistors connected in series to each of the plurality of current-generating active elements, wherein a current having a current level corresponding to said signal is generated by superposing the currents that pass through an selection transistor in which an ON-state is selected, among the selection transistors, based on the signal and the current-generating active elements connected in series to the selected selection transistor among the plurality of current-generating active elements.

According to the electronic circuit of the present invention, accuracy of current output from the current-generating active elements can be controlled for improvement in response to the signal.

In the electronic circuit, the transforming circuit further comprises a compensating transistor having a function for reducing the reference voltage value by a predetermined value or a function for adding a predetermined value to the reference voltage value.

According to the electronic circuit of the present invention, an applying voltage applied to the current-generating active elements can be controlled.

In the electronic circuit, each of the plurality of current-generating active elements includes at least one transistor.

According to the electronic circuit of the present invention, the threshold value voltage of the current-generating active elements can be compensated, thereby capable of easily constructing an electronic circuit for outputting a current in response to the signal with improved accuracy.

In the electronic circuit, the plurality of current-generating active elements are connected in parallel to each other.

By doing so, it is possible to easily form current-generating active elements each having a different gain factor.

In the electronic circuit, each of the plurality of current-generating active elements comprises one current generating transistor and the current generating transistors have different gain factors from each other.

According to the electronic circuit of the present invention, the number of the current-generating active elements can be reduced.

In the electronic circuit, at least one current-generating active element among the plurality of the current-generating active elements is connected in series to a unit transistor.

According to the electronic circuit of the present invention, it is possible to easily form the current-generating active elements each having a different gain factor.

In the electronic circuit, the compensating transistor has a characteristic almost equal to that of the unit transistor.

According to the electronic circuit of the present invention, the threshold value voltage of the unit transistor can be compensated.

In the electronic circuit, each of the constant current generating transistor and the compensating transistor is formed at adjacent positions and has almost the same threshold value voltage.

According to the electronic circuit of the present invention, the threshold value voltage of the unit transistor can be compensated.

In the electronic circuit, the transforming circuit comprises initializing means for turning on the compensating transistor.

According to the electronic circuit of the present invention, the transforming circuit can be appropriately controlled.

In the electronic circuit, the transforming circuit comprises voltage-stabilizing means.

By doing so, the voltage as much as the threshold voltage value of each constant current generating transistor can be stabilized to be supplied to the constant current generating transistor, thereby controllably improving the accuracy of the constant current generating transistor.

In the electronic circuit, the voltage-stabilizing means comprises capacitors.

By doing so, the voltage-stabilizing means can be easily constructed.

An electro-optical device according to the present invention comprises a control circuit for outputting digital luminance gradation data, a driving circuit for generating an analog driving signal based on the digital luminance gradation data, and a pixel circuit for driving an electro-optical element based on the analog driving signal, wherein the driving circuit changes the value of a reference voltage by a converting circuit, supplies it to control terminals of a plurality of current-generating active elements, establishes a conduction state of the plurality of current-generating active elements, selects some of the plurality of current-generating active elements based on the digital luminance gradation data, and superposes currents that pass through an current-generating active elements selected by the digital luminance gradation data, among the plurality of current-generating active elements, to thereby generate an analog driving signal having a current level corresponding to the digital luminance gradation data.

According to the electro-optical device of the present invention, the current output from the current-generating active elements can be controlled with an excellent accuracy in response to the digital luminance gradation data.

The electro-optical device of the present invention comprises a control circuit for outputting the digital luminance gradation data; a driving circuit for generating an analog driving signal based on the digital luminance gradation data; and a pixel circuit for driving a current driving element based on the analog driving signal, wherein the driving circuit comprises a plurality of current-generating active elements; a transforming circuit for generating an applied voltage which is applied to control terminals of the plurality of current-generating active elements by changing a reference voltage; and selection transistors connected in series to each of the plurality of current-generating active elements, wherein a current having a current level corresponding to said signal is generated by superposing the current that pass the selection transistor in which an ON-state is selected, among the selection transistors, based on the signal and the current-generating active elements connected in series to the selected selection transistor among the plurality of current-generating active elements.

According to the electro-optical device of the present invention, the current output from the current-generating active elements can be controlled with an excellent accuracy in response to the digital luminance gradation data.

In the electro-optical device, the transforming circuit includes a compensating transistor having a function for reducing the reference voltage value by a predetermined value or a function for adding a predetermined value to the reference voltage value.

According to the electro-optical device of the present invention, the applying voltage applied to the current-generating active elements can be controlled.

In the electro-optical device, each of the plurality of current-generating active elements comprises at least one transistor.

According to the electro-optical device of the present invention, the current-generating active elements each having a different gain factor can be easily formed.

In the electro-optical device, the plurality of current-generating active elements are connected in parallel to each other.

According to the electro-optical device of the present invention, the current-generating active elements each having a different gain factor can be easily formed.

In the electro-optical device, each of the plurality of current-generating active elements comprises a current generating transistor, and the current generating transistors have different gain factors from each other.

According to the electro-optical device of the present invention, the number of the current-generating active elements can be reduced.

In the electro-optical device, at least one of the plurality of current-generating active elements is connected in series to a unit transistor.

According to the electro-optical device of the present invention, the current-generating active elements each having a different gain factor can be easily formed.

In the electro-optical device, the compensating transistor is a transistor having a characteristic almost same as that of the unit transistor.

According to the electro-optical device of the present invention, the threshold value voltage of the unit transistor can be compensated.

In the electro-optical device, each of the constant current generating transistor and the compensating transistor is formed at adjacent position, and has almost same threshold value voltage.

According to the electro-optical device of the present invention, the threshold value voltage of the unit transistor can be compensated.

In the electro-optical device, the transforming circuit includes initializing means for turning on the compensating transistor.

According to the electro-optical device of the present invention, the transforming circuit can be appropriately controlled.

In the electro-optical device, the transforming circuit includes voltage-stabilizing means.

By doing so, the voltage as much as the threshold value voltage of each constant current generating transistor can be stabilized to be supplied to the constant current generating transistor, thereby capable of controllably improving the accuracy of the constant current generating transistor.

In the electro-optical device of the present invention, the voltage-stabilizing means includes capacitors.

By doing so, it is possible to easily construct voltage-stabilizing means.

In the electro-optical device, the electro-optical element is an EL element.

According to the electro-optical device of the present invention, the accuracy of luminance of the EL element can be controllably improved in response to the digital luminance gradation data.

In the electro-optical device, the EL element comprises a light-emitting layer made up of organic materials.

According to the electro-optical device of the present invention, the accuracy of the luminance at the organic EL element can be controllably improved in response to the digital luminance gradation data.

The electronic apparatus of the present invention is packaged with electronic circuits according to Claims 1 to 12.

According to the present invention, an electronic apparatus having a display unit with excellent luminance gradation can be provided.

The electronic apparatus according to the present invention is packaged with electro-optical devices defined in Claims 13 to 26.

According to the present invention, an electronic apparatus having a display unit with excellent display quality can be provided.

### BRIEF DESCRIPTION OF THE DRAWINGS

FIG. 1 is a block circuit diagram illustrating a circuit construction of an organic EL display according to a first embodiment of the present invention.

FIG. 2 is a block circuit diagram illustrating inner circuit constructions of a display panel part and a data line driving circuit according to the first embodiment of the present invention.

FIG. 3 is a block diagram illustrating an inner circuit construction of a unit line driver according to the first embodiment of the present invention.

FIG. 4 is a perspective view illustrating a construction of a mobile type personal computer according to a second embodiment of the present invention.

FIG. 5 is a perspective view illustrating a construction of a mobile phone according to the second embodiment of the present invention.

FIG. 6 is a diagram illustrating a circuit construction of a second current-supplying transistor 33b constructed by connecting unit transistors Qp in parallel according to the other example.

FIG. 7 is a diagram illustrating a circuit construction of a third current-supplying transistor 33c constructed by connecting unit transistors Qp in parallel according to the other example.

FIG. 8 is a diagram illustrating a circuit construction of a fourth current-supplying transistor 33d constructed by connecting unit transistors Qp in parallel according to the other example.

FIG. 9 is a diagram illustrating a circuit construction of a fifth current-supplying transistor 33e constructed by connecting unit transistors Qp in parallel according to the other example.

FIG. 10 is a diagram illustrating a circuit construction of a sixth current-supplying transistor 33f constructed by connecting unit transistors Qp in parallel according to the other example.

FIG. 11 is a diagram illustrating a circuit construction of a first current-supplying transistor 33a constructed by connecting unit transistors Qs in series according to the other example.

FIG. 12 is a diagram illustrating a circuit construction of a second current-supplying transistor 33b constructed by connecting the unit transistors Qs in series according to the other example.

FIG. 13 is a diagram illustrating a circuit construction of a third current-supplying transistor 33c constructed by connecting the unit transistors Qs in series according to the other example.

FIG. 14 is a diagram illustrating a circuit construction of a fourth current-supplying transistor 33d constructed by connecting the unit transistors Qs in series according to the other example.

FIG. 15 is a diagram illustrating a circuit construction of a fifth current-supplying transistor 33e constructed by connecting the unit transistors Qs in series according to the other example.

FIG. 16 is a circuit construction diagram illustrating a construction of a data line driving circuit according to a conventional electro-optical device.

FIG. 17 is a circuit diagram of a digital-analog converting circuit according to a conventional electro-optical device.

### DETAILED DESCRIPTION OF PREFERRED EMBODIMENTS

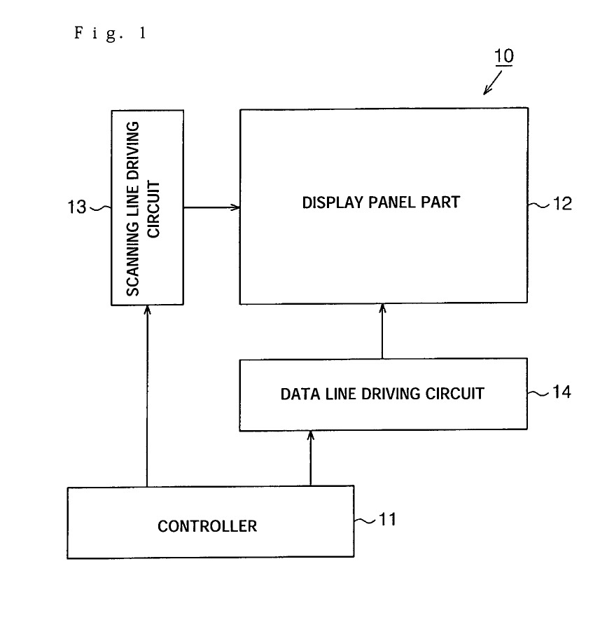

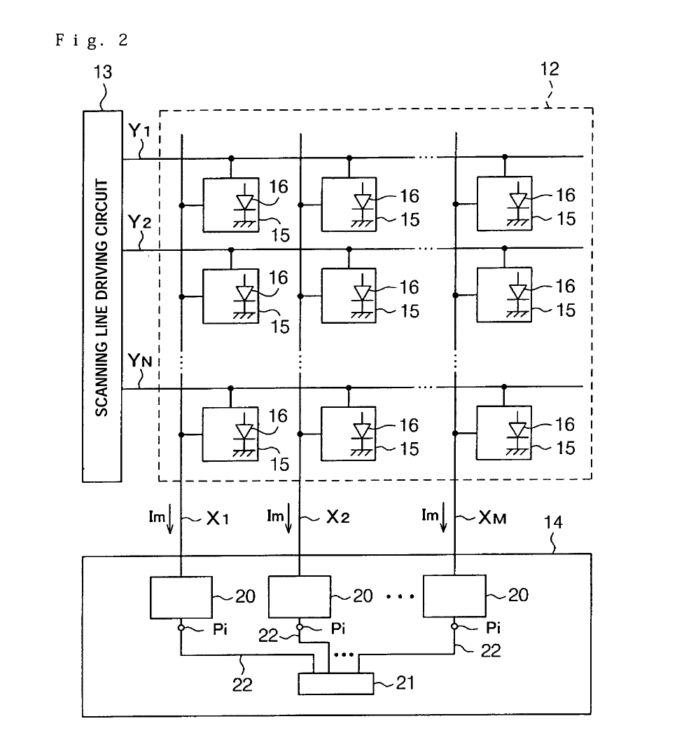

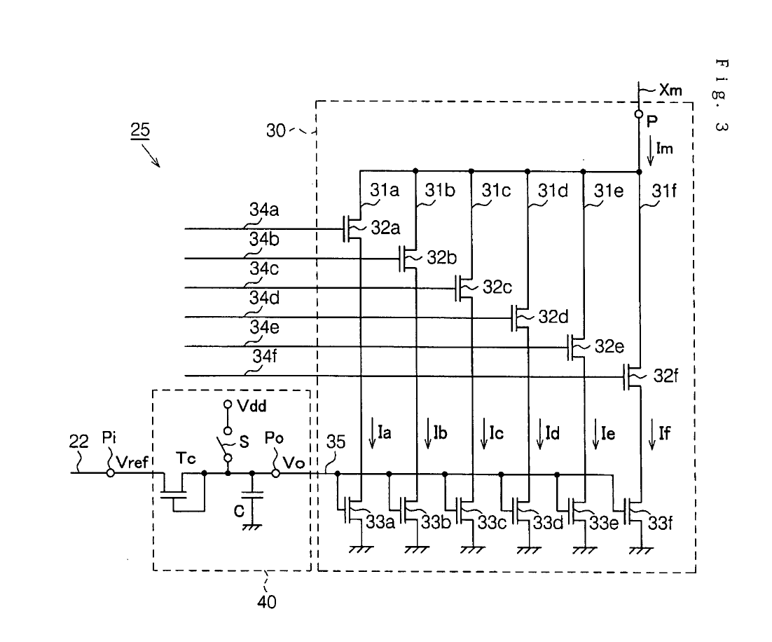

Hereinafter, a first embodiment of the present invention will be described in detail with reference to FIGS. 1 to 3. FIG. 1 is a block circuit diagram for illustrating a circuit construction of an organic EL display 10 as an electro-optical device. FIG. 2 is a block circuit diagram for illustrating an inner circuit construction of a display panel part and a data line driving circuit. FIG. 3 is a circuit diagram for illustrating an inner circuit construction of a unit line driver.

The organic EL display 10 includes a controller 11 as a control circuit, a display panel part 12, a scanning line driving circuit 13, and a data line driving circuit 14. Further, the organic EL display 10 in the first embodiment of the present invention is an organic EL display of active matrix driving method.

The controller 11, the scanning line driving circuit 13, and the data line driving circuit 14 of the organic EL display 10 may be respectively constructed as an independent electronic part. For example, the controller 11, the scanning line driving circuit 13, and the data line driving circuit 14 may be respectively constructed by one chip of semiconductor integrated circuit device. Further, all or part of the controller 11, the scanning line driving circuit 13, and the data line driving circuit 14 may be constructed in programmable IC chips and then functions thereof may be embodied in terms of software by programs stored in the IC chips.

The controller 11 is electrically connected to the display panel part 12 via the scanning line driving circuit 13 and the data line driving circuit 14. The controller 11 serves to output a scanning signal to the scanning line driving circuit 13 and simultaneously output to the data line driving circuit 14 image data as digital luminance gradation data. Further, in the first embodiment of the present invention, the image data is a 6-bit digital signal.

As illustrated in FIG. 2, the display panel part 12 has a construction that a plurality of pixel circuits 15 having an organic EL element 16 as a current-optical element is arranged in matrix shape, and in the current-optical element, its light-emitting part is made up of organic materials.

The pixel circuits 15 are connected to a scanning driving circuit 13 via a plurality of scanning lines Yn (n=1 to N; n is an integer) extending in the direction of row. Further, each pixel circuit 15 is connected to a data line driving circuit 14 via a plurality of data lines Xm (m=1 to M; m is an integer) extending in the direction of column.

Each pixel circuit 15 controls a luminance gradation of the organic EL element 16 in accordance with an analog output current Im as an analog driving signal output from the data line driving circuit 14. To be more specific, the pixel circuits 15 are disposed with generating circuits (not shown) for generating a current corresponding to the analog output current Im. Each generating circuit is connected to data lines Xm and supplies a current corresponding to the analog output current Im output from the data line driving circuit 14 to the organic EL element 16. Further, the luminance gradation of the organic EL elements 16 is controlled in accordance with the analog output current Im.

The scanning line driving circuit 13 selects one of the scanning lines out of the plurality of scanning lines Yn disposed at the display panel part 12 based on the scanning control signals output from the controller 11 to output the scanning line signal to the selected scanning line.

As shown in FIG. 2, the data line driving circuit 14 includes a plurality of unit line drivers 20 and a power source supply part 21. Each unit line driver 20 is electrically connected to the power source supply part 21 via each power source line 22.

As shown in FIG. 3, the unit line driver 20 includes 6-bit current-output type D/A converting circuit 25 as an electronic circuit. The current output type D/A converting circuit 25 comprises a D/A converting part 30 and a compensating circuit part 40. The D/A converting part 30 is disposed with analog output signal lines 31a to 31f, first to sixth switching transistors 32a to 32f as selection transistors, first to sixth current-supplying transistors 33a to 33f as current-generating active elements, and first to sixth digital input signal lines 34a to 34f.

Analog output signal lines 31a to 31f are arranged in parallel to each other and are connected to an analog output terminal P. Analog output terminal P is connected to the data lines Xm. The analog output signal lines 31a to 31f are respectively connected to each drain of the first to sixth switching transistors 32a to 32f.

Each source of the first to sixth switching transistors 32a to 32f is connected to each drain of the first to sixth current-supplying transistors 33a to 33f. Further, each gate of the first to sixth switching transistors 32a to 32h is connected to each of the first to sixth digital input signal lines 34a to 34f. The first to sixth digital input signal lines 34a to 34f are connected to the controller 11.

The first to sixth current-supplying transistors 33a to 33f, each functioning as a transistor, are commonly connected at each gate as control terminals thereof to a voltage supply line 35. The voltage supply line 35 is connected to an output port Po of the compensating circuit part 40 as a transforming circuit. The first to sixth current-supplying transistors 33a to 33f are respectively transistors, each functioning as a constant current source for outputting a predetermined current, and are all n channel FETs.

To be more specific, each threshold value voltage of the current-supplying transistors 33a to 33f is close to Vth. Further, a current flowing in a saturation domain at each transistor 33a to 33f is In (n=a, b, . . . , f) which can be defined as below.

In=(½)βn(Vo−Vthn)²

wherein βn (n =a, b, . . . , f) is each gain factor of the first to sixth current-supplying transistors 33a to 33f. In the present embodiment, a relative ratio of the gain factor βa to βf of each current-supplying transistor 33a to 33f is set up as 1:2:4:8:16:32, respectively.

The Vo is a driving voltage as an applying voltage applied to each gate of each current-supplying transistor 33a to 33f. In the current-supplying transistors 33a to 33f, the driving voltage Vo is applied and then each conduction state is set to ON-state.

The D/A converting circuit 25 is formed on one chip. For example, the current-supplying transistors 33a to 33f are formed at adjacent positions to each other, so that it is possible to restrain as much as disregarding variations of the threshold value voltage Vthn of each current-supplying transistor 33a to 33f. At this time, each threshold value voltage Vthn is almost the same value regardless of the current-supplying transistors 33a to 33f. Further, in the present embodiment, each threshold value voltage Vthn is defined as Vth1.

Then, each current output from the first to sixth current-supplying transistors 33a to 33f is In (n=a, b, . . . , f) which is defined as below.

In=(½)βn(Vo−Vth1)²

The ON-OFF control of the first to sixth switching transistors 32a to 32f is carried out by a 6-bit image data output from the controller 11. The lowermost bit of the 6-bit image data is output to the first switching transistor 32a via a first digital input signal line 34a, which has the smallest gain factor (in other words, a relative value of β is 1). Further, the uppermost bit of the 6-bit image data is output to the sixth switching transistor 32f via a sixth digital input signal line 34f, which has the largest gain factor (in other words, a relative value of β is 32).

As a result, the D/A converting part 30 outputs from an analog output terminal P a driving signal having an analog output current Im corresponding to an image data output from the controller 1. Further, the analog output current Im output from the analog output terminal P is supplied to the pixel circuits 15 via the data line Xm.

As shown in FIG. 3, the compensating circuit part 40 consists of a voltage rising transistor Tc as a compensating transistor, a switch S, and a capacitor C as a voltage-stabilizing means. The voltage rising transistor Tc is formed near the first to sixth current-supplying transistors 33a to 33f as n channel FET.

Source of the voltage-rising transistor Tc is connected to an input port Pi connected to the power source line 22 and to which a reference voltage Vref supplied from the power source supply part 21 is applied.

A drain of the voltage-rising transistor Tc is connected to a gate thereof. Drain of the voltage rising transistor Tc is connected to the voltage supply line 35 commonly connected to gates of the first to sixth current-supplying transistors 33a to 33f via the output port Po. Further, between the drain of the voltage-rising transistor Tc and the output port Po, there is connected a capacitor C in parallel in relation to the ground. The capacitor C is a capacitor functioning as a voltage-stabilizing means for stably supplying the driving voltage Vo raised in voltage thereof by the voltage-rising transistor Tc to the output port Po, and is not an essential element in principle.

The gate of the voltage rising transistor Tc is connected to an initial set power source Vdd via a switch S. Here, the switch S and the initial set power source Vdd, functioning as initializing means, are set up as Vdd≧Vref+Vthc in order to turn on the voltage-rising transistor Tc when the threshold value voltage of the voltage rising transistor Tc is Vthc. An initial state of the switch S is an OFF state. The switch S maintains an ON state during a constant period at a predetermined timing and carries out an ON control of the voltage rising transistor Tc.

In the compensating circuit part 40 thus described, the reference voltage Vref is supplied to the input port Pi from the power source supply part 21 via a power source line 22 and also, when the switch S is turned on, the voltage-rising transistor Tc is turned on. Further, there is generated at the drain of the voltage-rising transistor Tc a driving voltage Vo raised in voltage as much as threshold voltage Vthc of the voltage rising transistor Tc in addition to reference voltage Vref supplied via the input port Pi. In other words, the driving voltage Vo occurring at the drain of the voltage-rising transistor Tc can be represented as Vo=Vref+Vthc. The driving voltage Vo is output to the output port Po via the capacitor C. Further, currents In flowing in each of the current-supplying transistors 33a to 33f can be defined as below.

In=(½)βn(Vo−Vth1)² =(½)βn(Vref+Vthc−Vth1)²

Wherein the voltage-rising transistor Tc is arranged to be disposed near the first to sixth current-supplying transistors 33a to 33f, and then the threshold value voltage Vthc of the voltage-rising transistor Tc is so controlled to be at the approximately same value as that of the threshold value voltage Vth1 of the first to sixth current-supplying transistor 33ato 33f, whereby Vthc =Vth1. As a result, each current In flowing in each of the current-supplying transistors 33a to 33f can be defined as below.

In=(½)βn(Vref)².

Here, each current In flowing in the first to sixth current-supplying transistors 33a to 33f does not depended on the threshold value voltage Vth1. As a result, the analog output current Im output from each unit line driver 20 is not differentiated by the formation position of each unit line driver 20 even though based on the same image data. In other words, no characteristic of the luminance gradation at organic EL element 16 is changed at each pixel circuit 15. As a result, good display quality of electro-optical device and electronic apparatus can be provided.

Now, following characteristics can be obtained by the electronic circuit and the electro-optical device according to the present embodiment.

(1) In each unit line driver 20 according to the present embodiment, each gate of the first to sixth current-supplying transistors 33a to 33f is connected to the compensating circuit part 40 equipped with voltage rising transistor Tc for raising the threshold value voltage Vth1 of the first to sixth current-supplying transistors 33a to 33f. By doing so, the driving voltage Vo applied to each gate of the current-supplying transistor 33a to 33f becomes the reference voltage.Vref. Therefore, the current In flowing in the current-supplying transistors 33a to 33f does not depended on each threshold value voltage Vth. As a result, no characteristic of luminance gradation of the organic EL element 16 in every pixel circuit 15 is changed. Therefore, good display quality of electro-optical device and electronic apparatus can be provided.

(2) In each unit line driver 20 according to the present embodiment, the voltage rising transistor Tc is disposed in the vicinity of the first to sixth current-supplying transistors 33a to 33f. Therefore, it is possible to easily form a voltage rising transistor Tc for raising the voltage having an approximately same value as that of threshold value voltage Vth of the first to sixth current-supplying transistors 33a to 33f.

(3) In the present embodiment, a capacitor C is connected in parallel in relation to the ground between the drain of the voltage rising transistor Tc and the output port Po. Therefore, the driving voltage Vo raised by the voltage-rising transistor Tc can be stably supplied to each gate of the first to sixth current-supplying transistors 33a to 33f. As a result, display quality can be further upgraded.

### Second Embodiment

Next, application of the electronic apparatus of the organic EL display 10 as an electro-optical device as described in the first embodiment will be described in detail with reference to FIGS. 4 and 5. The organic EL display 10 can be applied to electronic apparatuses such as mobile type personal computers, mobile phones, digital cameras or the like.

FIG. 4 is a perspective view for illustrating a construction of a mobile type personal computer. In FIG. 4, the personal computer 50 includes a main body part 52 having a keyboard 51 and a display unit 53 using the organic EL display 10. Even in this embodiment, the display unit 53 using the organic EL display 10 has the same effect as that of the first embodiment. As a result, a mobile type personal computer 50 mounted with a display unit 53 having an excellent luminance gradation can be provided.

FIG. 5 is a perspective view for illustrating a construction of a mobile phone. In FIG. 5, the mobile phone 60 includes a plurality of manipulating buttons 61, an earpiece 62, a mouthpiece 63, and a display unit 64 using an organic EL display 10. Even in this embodiment, the display unit 64 using the organic EL display 10 has the same effect as that of the first embodiment. As a result, a mobile phone 60 with a display unit 64 having an excellent luminance gradation can be provided.

Further, the second embodiment of the present invention is not limited thereto and may be applied to the following embodiments.

In the second embodiment, each current-generating active element is constructed with one current-supplying transistor 33a to 33f. It should be apparent that a plurality of unit transistors Qp, each having an approximately same gain factor β and threshold value voltage, may be connected in parallel to thereby form a current-generating active element. At this time, ratio of gain factor of the current-generating active element comprising the plurality of unit transistors is established at 1:2:4:8:16:32. Further, a voltage rising transistor Tc may be made of the unit transistor Qp.

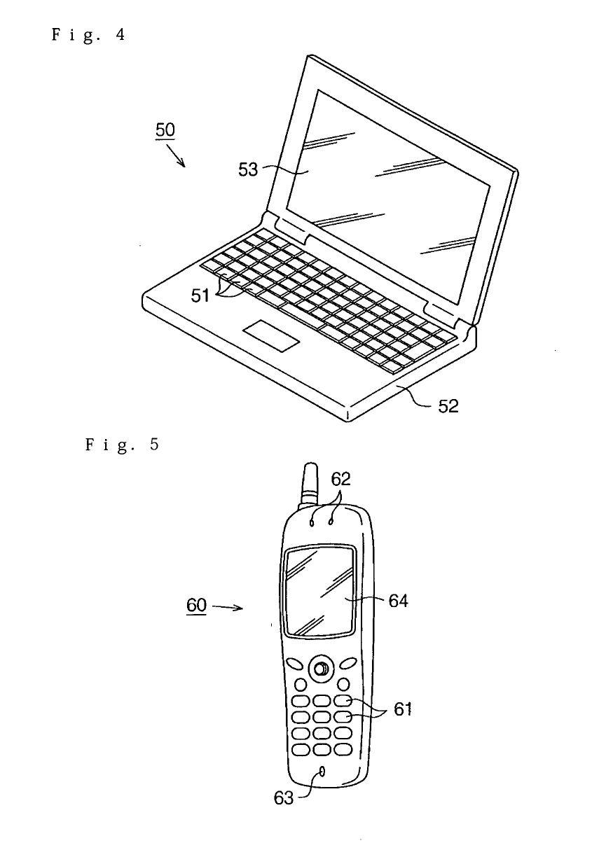

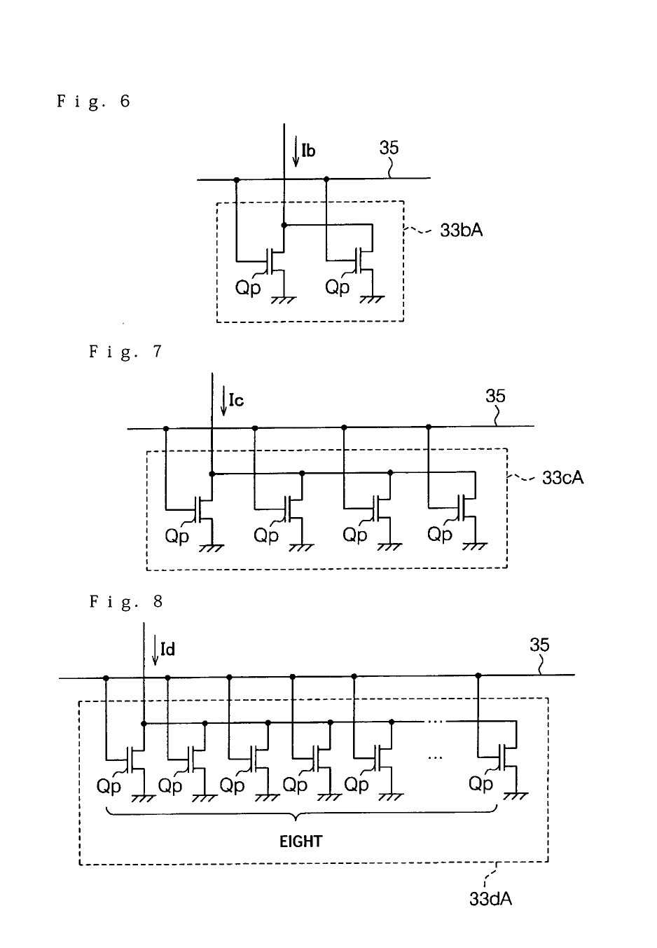

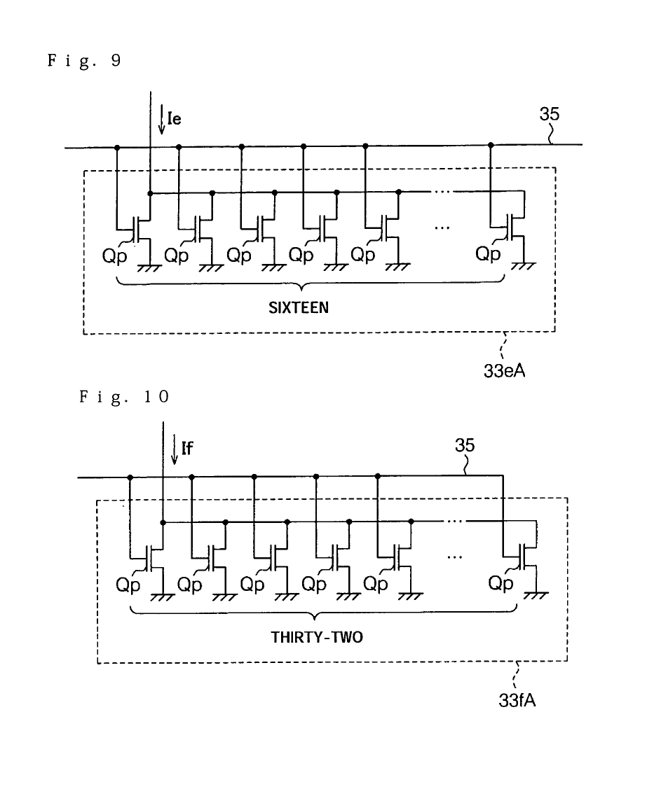

For example, as illustrated in FIG. 6, a current-generating active element 33bA corresponding to a second current-supplying transistor 33b in the first embodiment is constructed by respectively connecting two unit transistors Qp in parallel to each other. Likewise, as illustrated in FIG. 7, a current-generating active element 33cA corresponding to a third current-supplying transistor 33c is constructed by respectively connecting four unit transistors Qp in parallel. Likewise, as shown in FIG. 8, a current-generating active element 33dA corresponding to a fourth current-supplying transistor 33d is constructed by respectively connecting eight transistors Qp in parallel. Likewise, as shown in FIG. 9, a current-generating active element 33eA corresponding to a fifth current-supplying transistor 33e is constructed by respectively connecting sixteen unit transistors Qp in parallel. Likewise, as illustrated in FIG. 10, a current-generating active element 33fA corresponding to a sixth current-supplying transistor 33f is constructed by respectively connecting thirty-two unit transistors Qp in parallel. Ratio of gain factor for each current-generating active element 33bA to 33eA can be established at 1:2:4:8:16:32 by constructing each current-generating active element 33bA to 33fA as described above.

Further, the current-generating active elements 33bA to 33fA are respectively connected to each other and also a voltage-rising transistor Tc is constructed by the unit transistor Qp. Therefore, it is possible to easily construct the voltage-rising transistor Tc.

In the aforementioned embodiments, each current-generating active element is constructed with one current-supplying transistor 33a to 33f. A plurality of unit transistors Qs each having an approximately same gain factor β and threshold value voltage may be connected in series to form a current-generating active element. At this time, the ratio of the gain factor of the current-generating active element comprising a plurality of unit transistors is established at 1:2:4:8:16:32. Further, the voltage rising transistor Tc is constructed by unit transistor Qs.

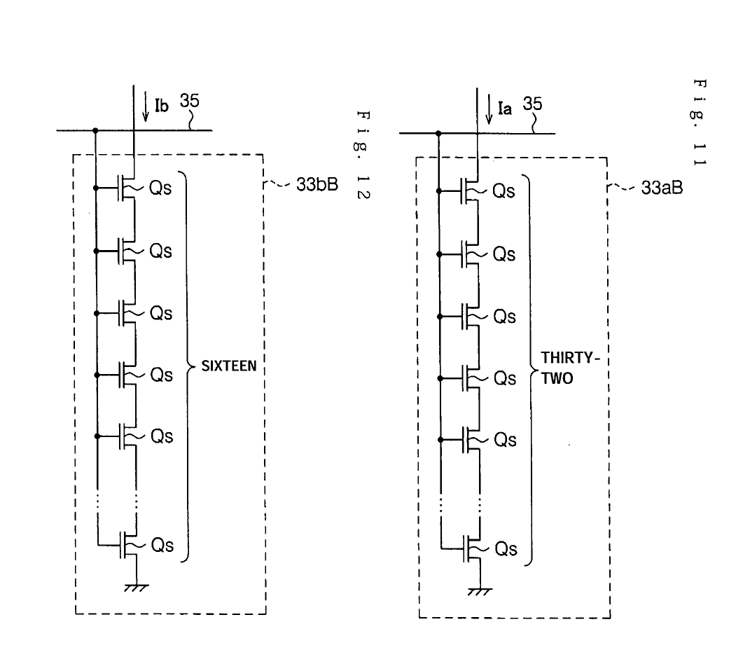

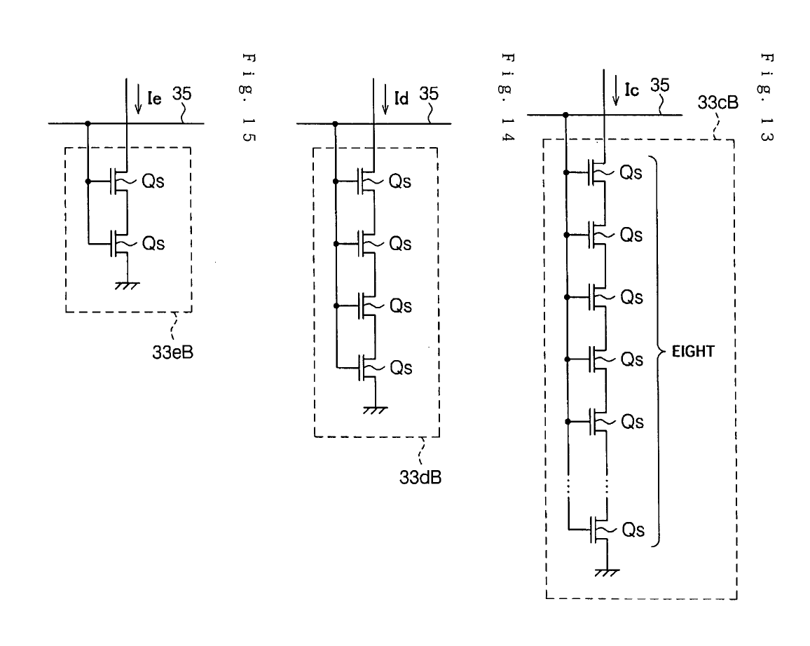

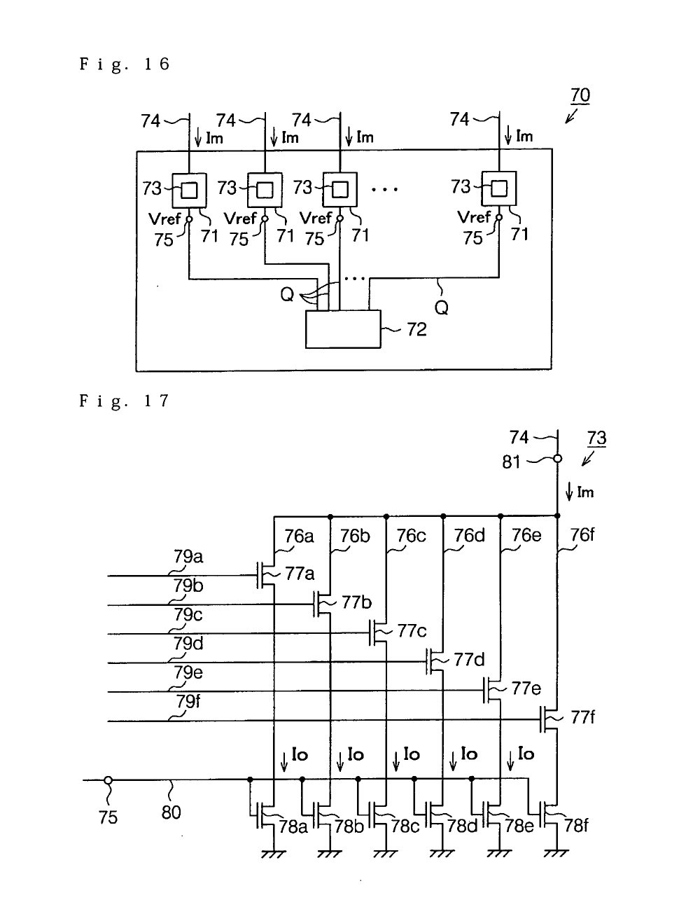

For example, as illustrated in FIG. 11, a current-generating active element 33aB corresponding to the first current-supplying transistor 33 in the first embodiment is constructed by respectively connecting thirty two unit transistors Qs in series. Likewise, as shown in FIG. 12, a current-generating active element 33bB corresponding to the second current-supplying transistor 33b is constructed by respectively connecting sixteen unit transistors Qs in series. Likewise, as shown in FIG. 13, a current-generating active element 33cB corresponding to the third current-supplying transistor 33c is constructed by respectively connecting eight-unit transistors Qs in series. Likewise, as shown in FIG. 14, a current-generating active element 33dB corresponding to the fourth current-supplying transistor 33d is constructed by respectively connecting four unit transistors Qs in series. Likewise, as illustrated in FIG. 15, a current-generating active element 33eB corresponding to the fifth current-supplying transistor 33e is constructed by respectively connecting two unit-transistors Qs in series. By constructing each current-generating active element 33aB to 33eB as described above, ratio of the gain factor of each current-generating active element 33aB to 33eB can be established at 1:2:4:8:16:32.

Further, the current-generating active elements 33bA to 33fA are respectively connected to each other and also the voltage rising transistor Tc is constructed with the unit transistor Qp. Therefore, it is easy to construct the voltage rising transistor Tc.

Although the capacitor C is connected to the compensating circuit part 40 in the aforementioned embodiments, it may be possible that a compensating circuit which is not connected to the capacitor C is used. By doing so, the circuit configuration of a compensating circuit part 40 can be simply constructed to reduce the manufacturing cost of the compensating circuit part 40.

In the aforementioned embodiments, although first to sixth current-supplying transistors 33a to 33f are all n channel FETs, they are not limited thereto but may be p channel FETs. At this time, the voltage rising transistor Tc outputs as a driving voltage Vo a voltage value reduced the reference voltage Vref by the threshold value voltage Vthn (n=a, b, . . . , f) of the first to sixth current-supplying transistors 33a to 33f. By doing so, the same effect as that obtained in the first embodiment can be achieved.

Although the organic EL element 16 is used as a current driving element in the second embodiment, it may be applied to the other different current driving element. For example, it may be applied to a current driving element like light-emitting elements such as a LED or a FED.

Although an organic EL display 10 using a pixel circuit 15 having an organic EL element 16 is used as an electro-optical device in the second embodiment, it is apparent that a display using a pixel circuit having an inorganic EL element, in which a light-emitting layer is made up of inorganic materials, may be used.

What is claimed is:

1. An electronic circuit for changing a reference voltage value with a transforming circuit to supply it to control terminals of a plurality of current-generating active elements, establishing a conduction state of the plurality of the current-generating active elements, and selecting some of the plurality of current-generating active elements based on signals and generating a current having a current level corresponding to the signal by superposing currents passing through the current-generating active elements selected by the signal, among the plurality of current-generating active elements.

2. An electronic circuit, comprising:
a plurality of current-generating active elements;
a transforming circuit for generating an applied voltage which is applied to control terminals of the plurality of current-generating active elements by changing a reference voltage; and
selection transistors connected in series to each of the plurality of the current-generating active elements,
wherein a current having a current level corresponding to signals is generated by superposing the currents that pass through a selection transistor in which an ON-state is selected, among the selection transistors, based on the signal and the current-generating active elements connected in series to the selected selection transistor among the plurality of current-generating active elements.

3. The electronic circuit according to claim 1, wherein the transforming circuit comprises a compensating transistor having a function for reducing the reference voltage value by a predetermined value or a function for adding a predetermined value to the reference voltage value.

4. The electronic circuit according to claim 1, wherein each of the plurality of current-generating active elements comprises at least one transistor.

5. The electronic circuit according to claim 1, wherein the plurality of current-generating active elements are connected in parallel to each other.

6. The electronic circuit according to claim 1, wherein each of the plurality of current-generating active elements comprises one current generating transistor and the current generating transistors have different gain factors from each other.

7. The electronic circuit according to claim 1, wherein at least one current-generating active element among the plurality of the current-generating active elements is connected in series to a unit transistor.

8. The electronic circuit according to claim 7, wherein the compensating transistor is transistor having a characteristic almost equal to that of the unit transistor.

9. The electronic circuit according to claim 6, wherein the current generating transistors and the compensating transistors are formed at positions adjacent to each other and have almost the same threshold voltage value.

10. The electronic circuit according to claim 1, wherein the transforming circuit comprises initializing means for turning on the compensating transistor.

11. The electronic circuit according to claim 1, wherein the transforming circuit comprises voltage-stabilizing means.

12. The electronic circuit according to claim 11, wherein the voltage-stabilizing means comprises capacitors.

13. An electro-optical device, comprising:
a control circuit for outputting digital luminance gradation data;
a driving circuit for generating an analog driving signal based on the digital luminance gradation data; and
a pixel circuit for driving an electro-optical element based on the analog driving signal,
wherein the driving circuit changes a reference voltage value with a converting circuit to supply it to control terminals of a plurality of current-generating active elements and to establish a conduction state in the plurality of current-generating active elements, and selects some of the plurality of current-generating active elements based on the digital luminance gradation data, and superposes currents that pass through an current-generating active elements selected by the digital luminance gradation data, among the plurality of current-generating active elements, to thereby generate an analog driving signal having a current level corresponding to the digital luminance gradation data.

14. An electro-optical device, comprising:
a control circuit for outputting digital luminance gradation data;
a driving circuit for generating an analog driving signal based on the digital luminance gradation data; and
a pixel circuit for driving a current driving element based on the analog driving signal,
wherein the driving circuit comprises a plurality of current-generating active elements; a transforming circuit for generating an applied voltage which is applied to control terminals of the plurality of current-generating active elements by changing a reference voltage; and selection transistors connected in series to each of the plurality of current-generating active elements, and
wherein a current having a current level corresponding to said digital luminance gradation data is generated by superposing the currents that pass through a selection transistor in which an ON-state is selected, among the selection transistors, based on the signal and the current-generating active elements connected in series to the selected selection transistor among the plurality of current-generating active elements.

15. The electro-optical device according to claim 13, wherein the transforming circuit comprises a compensating transistor having a function for reducing the reference voltage value by a predetermined value or a function for adding a predetermined value to the reference voltage value.

16. The electro-optical device according to claim 13, wherein each of the plurality of current-generating active elements comprises at least one transistor.

17. The electro-optical device according to claim 13, wherein the plurality of current-generating active elements are connected in parallel to each other.

18. The electro-optical device according to claim 13, wherein each of the plurality of the current-generating active elements comprises a current generating transistor, and the current generating transistors have different gain factors from each other.

19. The electro-optical device according to claim 13, wherein at least one of the plurality of current-generating active elements is connected in series to a unit transistor.

20. The electro-optical device according to claim 19, wherein the compensating transistor is a transistor having a characteristic almost equal to that of the unit transistor.

21. The electro-optical device according to claim 18, wherein the current generating transistors and the compensating transistors are formed at positions adjacent to each other, and have almost the same threshold value voltage.

22. The electro-optical device according to claim 13, wherein the transforming circuit comprises initializing means for turning on the compensating transistor.

23. The electro-optical device according to claim 13, wherein the transforming circuit comprises voltage-stabilizing means.

24. The electro-optical device according to claim 23, wherein the voltage-stabilizing means comprises capacitors.

25. The electro-optical device according to claim 13, wherein the electro-optical element is an electroluminescent (EL) element.

26. The electro-optical device according to claim 25, wherein the EL element comprises a light-emitting layer made up of organic materials.

27. An electronic apparatus packaged with electronic circuits according to claim 1.

28. An electronic apparatus packaged with electro-optical devices according to claim 13.
